(19) United States
(12) Patent Application Publication
(10) Pub. No.: US 2025/0286931 A1
(43) Pub. Date: Sep. 11, 2025

(54) COMPUTER-IMPLEMENTED METHODS AND COMPUTER SYSTEMS FOR PROVIDING REMOTE ACCESS TO AN ELECTRONIC DEVICE

(71) Applicant: Remote Vision AI LLC, Palo Alto, CA (US)

(72) Inventors: Mirko Milojkovic, Sokobanja (RS); Herc Kwan, Palo Alto, CA (US); Kaori Shuji, Palo Alto, CA (US)

(73) Assignee: Remote Vision AI LLC, Palo Alto, CA (US)

(21) Appl. No.: 18/597,597

(22) Filed: Mar. 6, 2024

(51) Int. Cl. H04L 67/141

(52) U.S. Cl. CPC H04L 67/141

(57) ABSTRACT

A computer-implemented method for providing remote access to an electronic device, includes receiving data from the electronic device through a wired and/or a wireless connection. The computer-implemented method further includes encoding the received data into a format configured for streaming over a Wide Area Network (WAN). Furthermore, computer-implemented method includes modifying the encoded data using an Artificial Intelligence (AI) based algorithm to augment broadcast characteristics of the encoded data and generating AI-augmented broadcast data. Also, computer-implemented method includes broadcasting the AI-augmented broadcast data to a client device associated with a user, through the WAN.

### TECHNICAL FIELD

The present invention relates generally to remote computing. More specifically, the present invention relates to computer-implemented methods and computing systems that allow remote access to an electronic device for data acquisition and viewing, and remote control of the electronic device through Human Interface Devices (HIDs).

### BACKGROUND ART

Remote computing refers to the ability to access and control a computer or some other form of data processing electronic device from another location, typically through a network connection. Remote computing obviates the need for the physical presence of a user near the electronic device being controlled. However, the remote electronic device being controlled, and the local computing device being used to control the remote electronic device need to have remote desktop connection applications installed. However, once connected, several tasks such as opening and editing files, running applications, and even troubleshooting technical issues can be performed on the remote electronic device.

In popular and mainstream remote desktop connection applications, poor video quality and high latency (stuttering or slow response) are the main concerns. Higher video quality could be achieved at the expense of higher Central Processing Unit (CPU) or Graphics Processing Unit (GPU) consumption on a remote computer that is being monitored or controlled.

Therefore, there is a need in the art for computer-implemented methods and computing systems that do not suffer from the aforementioned deficiencies.

### OBJECTS OF THE INVENTION

Some of the objects of the present invention are as follows:

An object of the present invention is to provide computer-implemented methods and computing systems that allow remote connection with an electronic device without the need to have specialized software(s) installed on the electronic device or a local device being used to access the remote electronic device.

Another object of the present invention is to use an external device to achieve the highest quality and ultra-low latency video and audio delivery to a user via a browser.

It is also an object of the present invention, to use Artificial Intelligence based algorithms to further enhance the quality of video and audio data being delivered, and further reduce the latency in the delivery of the video and audio data while maintaining the hardware utilization as a constant.

### SUMMARY OF THE INVENTION

According to a first aspect of the present invention, there is provided a computer-implemented method for providing remote access to an electronic device. The computer-implemented method includes receiving data from the electronic device through a wired and/or wireless connection. Furthermore, the computer-implemented method includes encoding the received data into a format configured for streaming over a Wide Area Network (WAN). The computer-implemented method further includes modifying the encoded data using an Artificial Intelligence (AI) based algorithm to augment broadcast characteristics of the encoded data and generating AI-augmented broadcast data. Also, the computer-implemented method includes broadcasting the AI-augmented broadcast data to a client device associated with a user, through the WAN.

In one embodiment of the invention, the electronic device is selected from a group consisting of notebook PCs, tablet PCs, desktop PCs, web cameras, television sets, medical devices, and electronic devices capable of generating audiovisual data.

In one embodiment of the invention, the wired connection with the electronic device comprises a connection through one or more of an Ethernet cable, a Video Graphics Array (VGA) cable, a High-Definition Multimedia Interface (HDMI) cable, a Serial Digital Interface (SDI) cable, and a Universal Serial Bus (USB) cable.

In one embodiment of the invention, the data includes audiovisual data comprising aural data, visual data, and image data.

In one embodiment of the invention, the audiovisual data is collected using capturing software and video-audio capture libraries.

In one embodiment of the invention, the computer-implemented method further includes training the AI-based algorithm with the data in raw format, received from the electronic device, and/or the encoded data generated after the step of encoding.

In one embodiment of the invention, the AI-based algorithm is accessed from one or more of an Edge computing node and a cloud computing node.

In one embodiment of the invention, the AI-based algorithm is accessed locally using a non-dedicated node.

In one embodiment of the invention, the computer-implemented method further includes receiving control input signals from the client device and transmitting the control input signals to the electronic device through a Standalone Control Dongle (SCD).

In one embodiment of the invention, the AI-augmented broadcast data is broadcasted using a web server.

According to a second aspect of the present invention, there is provided a computer system for providing remote access to an electronic device. The computer system includes a processor. Furthermore, the computer system includes a memory unit operably connected to the processor. The memory unit is configured to store machine-readable instructions, the machine-readable instructions when executed by the processor, enable the processor to receive data from the electronic device through a wired and/or a wireless connection, encode the received data into a format configured for streaming over a Wide Area Network (WAN), modify the encoded data using an Artificial Intelligence (AI) based algorithm to augment broadcast characteristics of the encoded data and generate AI-augmented broadcast data, and broadcast the AI-augmented broadcast data to a client device associated with a user, through the WAN.

In one embodiment of the invention, the processor is further enabled to train the AI-based algorithm with the data in raw format, received from the electronic device, and/or the encoded data.

In one embodiment of the invention, the processor is further enabled to access the AI-based algorithm from one or more of an Edge computing node and a cloud computing node.

In one embodiment of the invention, the processor is further enabled to access the AI-based algorithm locally using a non-dedicated node.

In one embodiment of the invention, the processor is further enabled to receive control input signals from the client device and transmit the control input signals to the electronic device through a Standalone Control Dongle (SCD).

In one embodiment of the invention, the processor is further enabled to broadcast the AI-augmented broadcast data using a web server.

In the context of the specification, the term “processor” refers to one or more of a microprocessor, a microcontroller, a general-purpose processor, a Field Programmable Gate Array (FPGA), a Neural Processing Unit (NPU), a Graphics Processing Unit (GPU), a Tensor Processing Unit (TPU), an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “web server” refers to a computer system or an executable segment of machine-readable code that allows communication with client systems (such as a web browser or a standalone computer application) using the Hypertext Transfer Protocol (HTTP), a set of rules that define how web servers and clients exchange information. When a user types a URL into a web browser (acting as a client), the browser sends an HTTP request to the web server that hosts the website. The web server then processes the request and sends back an HTTP response that contains the requested content.

In the context of the specification, the phrase “application server” refers to a computer system or an executable segment of machine-readable code that provides an environment for running software applications and be accessed by users and other devices such as web servers, database servers, Application Program Interface (API) servers, compute nodes and the like. Application servers handle tasks such as memory allocation, security, and concurrency control. Application servers may also offer features like load balancing and failover to ensure high availability and scalability.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1A illustrates an example environment in which several embodiments of the present invention may be implemented;

FIG. 1B illustrates a communication interface of an electronic device, in accordance with an embodiment of the present invention;

FIG. 1C illustrates a representation of a Standalone Control Dongle (SCD), in accordance with an embodiment of the present invention;

FIG. 2 illustrates a computer-implemented method for providing remote access to an electronic device, in accordance with an embodiment of the present invention;

FIG. 3 illustrates an information flow diagram depicting a flow of data from the electronic device to an application server, in accordance with an embodiment of the present invention;

FIG. 4 illustrates an information flow diagram depicting the generation of Artificial Intelligence (AI) augmented broadcast data, in accordance with an embodiment of the present invention;

FIG. 5 illustrates an information flow diagram depicting broadcasting of the AI-augmented broadcast data to several client devices through a web server, in accordance with an embodiment of the present invention; and

FIG. 6 illustrates an information flow diagram depicting transmission of control input signals from the several client devices to the electronic device, through the SCD, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

Embodiments of the present invention provide computer-implemented methods and computer systems for providing remote access to an electronic device. The invention is enabled through a dedicated device located remotely and connected to the electronic devices through several wired and/or wireless connections. The dedicated device, also referred to as “the application server” would receive raw audiovisual and other forms of data from the electronic device and encode the raw data into formats that are suitable for streaming over a Wide Area Network (WAN) such as the Internet. Furthermore, the application server would either locally or through communication with an Edge computing node or a cloud computing node deploy Artificial Intelligence (AI) based algorithms to augment the encoded data to generate AI-augmented broadcast data. The AI-based algorithms may in turn be further trained using the raw data, through machine-learning algorithms, by the application server. The AI-augmented broadcast data may then be streamed through a web-based server to several client devices. The present invention also discloses a Standalone Control Dongle (SCD) connected to the electronic device and the application server. The SCD enables control input signals from the several client devices to be transmitted to the electronic device for control of the electronic device using Human Interface Devices (HIDs) installed with the several client devices.

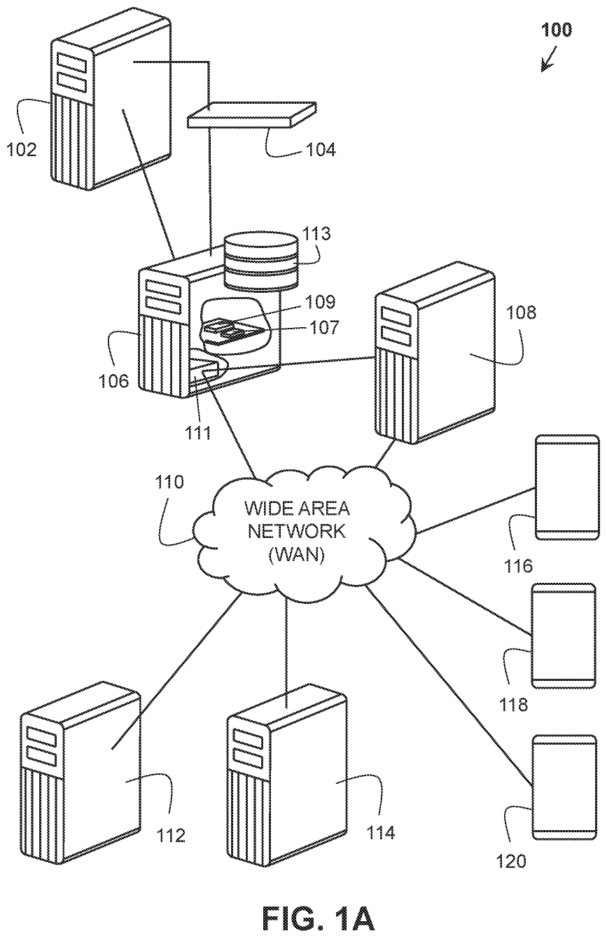

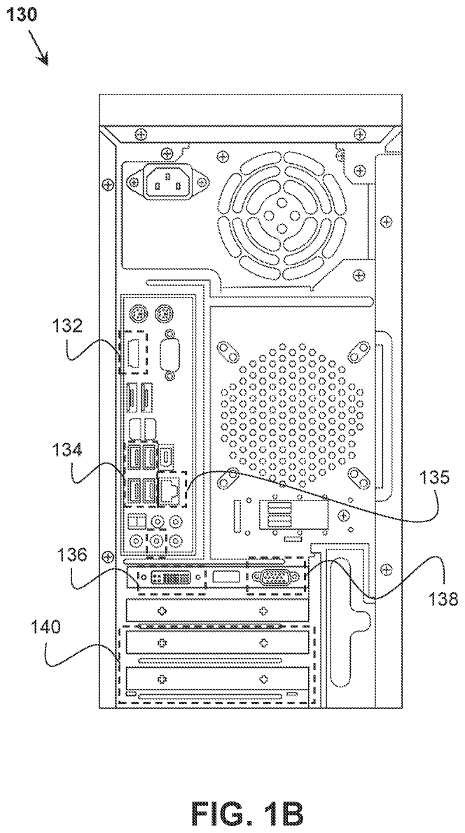

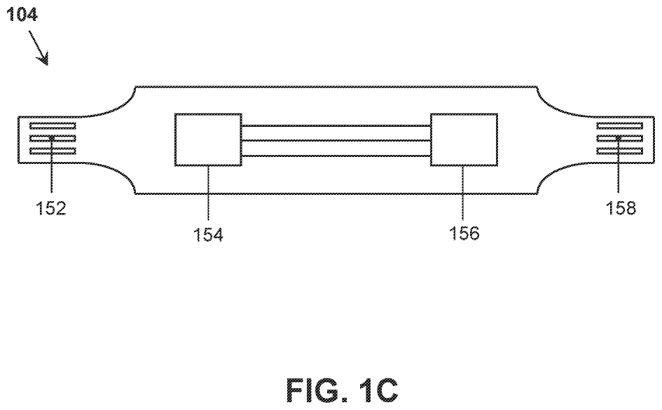

Several embodiments of the present invention will now be discussed in detail with reference to FIGS. 1A-6.

FIG. 1A illustrates an example environment 100 in which several embodiments of the present invention may be implemented. The example environment 100 includes an electronic device 102. The electronic device 102 is depicted as a desktop PC in FIG. 1A. However, in several embodiments of the invention, the electronic device 102 may be selected from a group consisting of notebook PCs, tablet PCs, desktop PCs, web cameras, television sets, medical devices, and electronic devices capable of generating audiovisual data. FIG. 1B illustrates a communication interface 130 of the electronic device 102, in accordance with an embodiment of the present invention. The communication interface 130 includes a High-Definition Multimedia Interface (HDMI) port 132, a Digital Visual Interface (DVI) port 136, a Video Graphics Array (VGA) port 138, several Universal Serial Bus (USB) ports 134, an Ethernet port 135 and network interface cards 140 for enabling wireless communication through protocols such as Wi-Fi, Bluetooth, ZigBee, etc.

Referring to FIG. 1A, the environment 100 further includes an application server 106 hosting an application representative of and enabling several embodiments of the present invention. In that regard, the application server 106 may include computing hardware resources such as a processor 107, a memory unit 109 configured to store machine-readable instructions during runtime, a storage device 113, and a server communication interface 111. Furthermore, there is connected a Standalone Control Dongle (SCD) 104 between the electronic device 102 and the application server 106. FIG. 1C illustrates a representation of the SCD 104, in accordance with an embodiment of the present invention. The SCD 104 includes a first SCD communication interface 152 configured to be connected with the application server 106. The first SCD communication interface 152 is in communication with a master processor 154. The master processor 154 is in communication with a slave processor 156. Furthermore, the slave processor 156 is in communication with a second SCD communication interface 158 configured to be connected with the electronic device 102.

Referring to FIG. 1A, the environment 100 further includes an Edge computing node 108 connected locally and securely to the application server 106. The Edge computing node 108 may be configured to host multiple machine learning-based Artificial Intelligence (AI) algorithms for the enhancement of encoded broadcast data. The Edge computing node 108 allows data to be processed and algorithms to be implemented locally without needing to connect to a remote device, such as a cloud computing node 112, enabling secure data handling and faster response times. The electronic device 102, the application server 106, and the Edge computing node 108 are connected to a Wide Area Network (WAN) 110. The WAN 110 may be implemented through combinations of several protocols and technologies such as HSPA, HSDPA, LTE, 802.11, 802.3, optical fiber, and the like. Further connected to the WAN 110 is the cloud computing node 112. Similar to the Edge computing node 108, the cloud computing node 112 may be also configured to host multiple machine learning-based Artificial Intelligence (AI) algorithms for the enhancement of the encoded broadcast data.

Further connected to the WAN 110 is a web server 114. In several embodiments of the invention, the web server 114 may include the capabilities of a WebRTC server for facilitating real-time communication between devices through peer-to-peer (P2P) communication. In several alternate embodiments of the invention, the web server 114 may be built-in or coded with the application server 106, without departing from the scope of the invention. Also connected to the WAN 110 are a plurality of client devices 116, 118, and 120. The plurality of client devices 116, 118, and 120 may be selected from a group consisting of desktop PCS, smartphones, notebook PCs, tablet PCs, and the like. Several embodiments of the present invention will now be elucidated using the environment 100 as a reference. However, a person skilled in the art would appreciate that the present invention as described in the following discussion may also be implemented in several alternate environments of computing devices without departing from the scope of the invention.

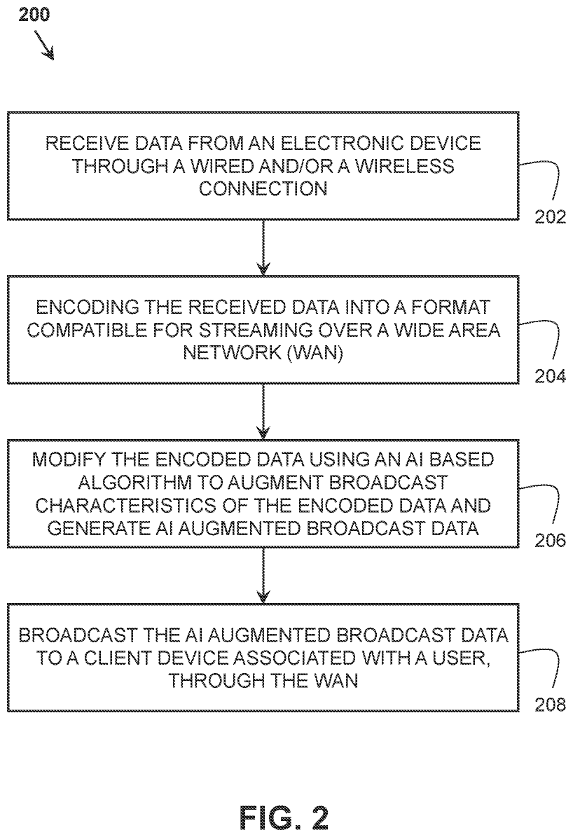

FIG. 2 illustrates a computer-implemented method 200 for providing remote access to the electronic device 102, in accordance with an embodiment of the present invention. The several steps of the method 200 have been performed by the processor 107 executing machine-readable instructions stored in the memory unit 109. The method 200 begins at Step 202 when the processor 107 receives data from the electronic device 102 through a wired and/or wireless connection. In several embodiments of the invention, the wired connection with the electronic device 102 comprises a connection through one or more of an Ethernet cable, a Video Graphics Array (VGA) cable, a High-Definition Multimedia Interface (HDMI) cable, a Serial Digital Interface (SDI) cable, and a Universal Serial Bus (USB) cable. Furthermore, the data may include audiovisual data including aural data, visual data, and image data. Furthermore, in several embodiments of the invention, the audiovisual data is collected using capturing software and video-audio capture libraries.

Video-audio capture libraries are software tools that allow applications to record video and audio from various sources like webcams, microphones, and screens. These libraries provide an easier way to interact with the hardware of the electronic device 102 and handle the complexities of capturing and encoding multimedia data, saving developers time and effort. Some of the examples of such libraries include Open-Source Computer Vision Libraries (OpenCV), PyAVCapture, FFmpeg, GStreamer, RecordRTC, Java Media Framework (JMF), JavaCV, etc.

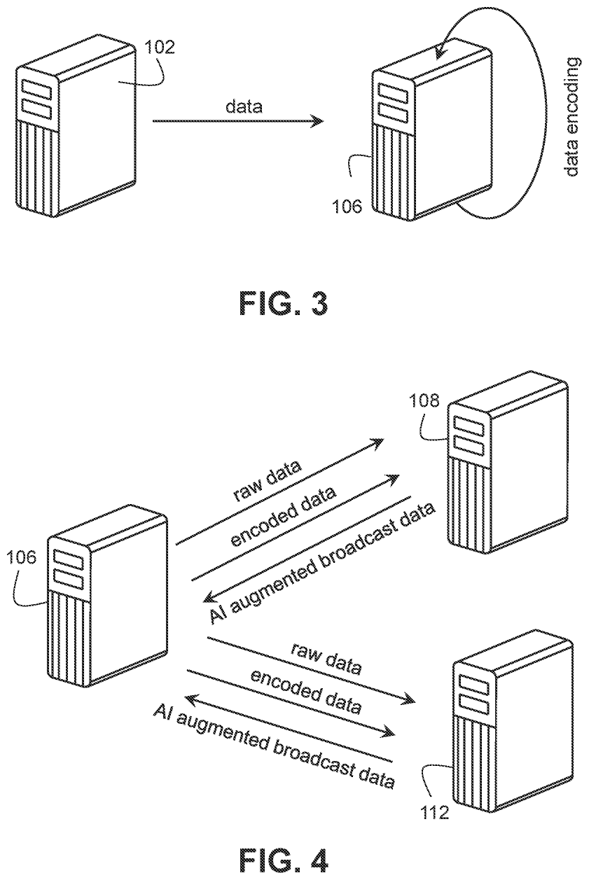

At Step 204, the processor 107 encodes the received data into a format configured for streaming over the WAN 110. In several embodiments, the memory unit 109 may include machine-readable instructions for two encoder pipes, viz. Encoder Pipe 0 and Encoder Pipe 1. The processor 107 executing the Encoder Pipe 0 may receive the raw audiovisual data and may deliver encoded or raw uncompressed audiovisual data. Furthermore, the processor 107 executing the Encoder Pipe 1 may receive the raw audiovisual data and deliver hardware or software encoded low latency audiovisual data in the format configured for streaming over the WAN 110. Some of the commonly known video codecs include H.264 (which is widely supported by web browsers), H.265, VP9, AV1, etc. Some of the commonly known audio codecs include Advanced Audio Coding (AAC), Opus, etc. FIG. 3 illustrates an information flow diagram depicting a flow of the data from the electronic device 102 to the application server 106, in accordance with an embodiment of the present invention.

At Step 206, the processor 107 modifies the encoded data using an Artificial Intelligence (AI) based algorithm to augment broadcast characteristics of the encoded data. As a consequence, the processor 107 generates AI-augmented broadcast data. In several embodiments of the invention, the AI-based algorithm is accessed from one or more of the Edge computing node 108 and the cloud computing node 112. However, in several alternate embodiments of the invention, the AI-based algorithm is accessed locally using a non-dedicated node coded within or connected to the application server 106. In several embodiments of the invention, the application server 106 may act as the local non-dedicated node, and code segments for implementing AI based algorithms may be stored in the storage device 113, and in the memory unit 109 during runtime.

In several embodiments of the invention, the processor 107 trains the AI-based algorithm with the data received from the electronic device 102. For example, the raw and uncompressed audiovisual data or other forms of data received on the execution of the Encoder Pipe 0 can be delivered to the Edge computing node 108, the cloud computing node 112, and/or the local non-dedicated node to train the AI-based algorithm through machine learning. In addition or alternately, hardware or software encoded low latency audiovisual data on the execution of Encoder Pipe 1 can also be delivered to the Edge computing node 108, the cloud computing node 112, and/or the local non-dedicated node to train the AI-based algorithm through machine learning. FIG. 4 illustrates an information flow diagram depicting the generation of Artificial Intelligence (AI) augmented broadcast data, in accordance with an embodiment of the present invention.

The use of AI offers several advantages, such as, but not limited to, content-aware encoding, quality enhancement, noise reduction, video upscaling, personalization and recommendation, content security, and accessibility. For example, the AI-based algorithm may analyze the content itself, understanding factors like scene complexity and motion. This allows for dynamic bitrate allocation, optimizing the encoding process to deliver the best possible quality at any given bandwidth, reducing buffering, and improving the viewing experience. Furthermore, the resolution of the audiovisual data can be increased, creating additional detail and improving overall quality. Furthermore, unwanted noise, such as grain or compression artifacts, can be identified and cleared from the audiovisual data leading to a cleaner and sharper viewing experience. Furthermore, audiovisual data can be scaled to fit higher-resolution displays, maintaining picture quality even on larger screens. The AI-based algorithm can also be used to detect and prevent copyright infringement by analyzing streamed content and identifying copyrighted material. Additionally, inappropriate content can be detected and flagged, enhancing safety and security measures for viewers. Captions and subtitles can be generated automatically, making streamed content more accessible to a wider audience, including those with hearing or other forms of learning disabilities.

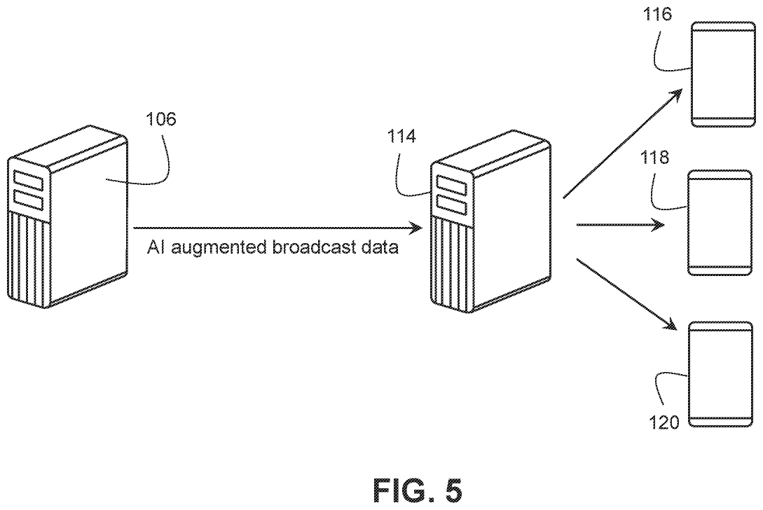

At Step 208, the processor 107 broadcasts the AI-augmented broadcast data to the plurality of client devices 116, 118, and 120 associated with several users, through the WAN 110. In several embodiments of the invention, the AI-augmented broadcast data is broadcasted using the web server 114 using protocols such as, but not limited to, WebRTC, DASH, HLS, and/or custom-developed low-latency protocols. The users in that regard would therefore be enabled to access the AI-augmented broadcast data through client software such as web browsers or dedicated stand-alone applications. FIG. 5 illustrates an information flow diagram depicting the broadcasting of the AI-augmented broadcast data to the plurality of client devices 116,118, and 120, in accordance with an embodiment of the present invention.

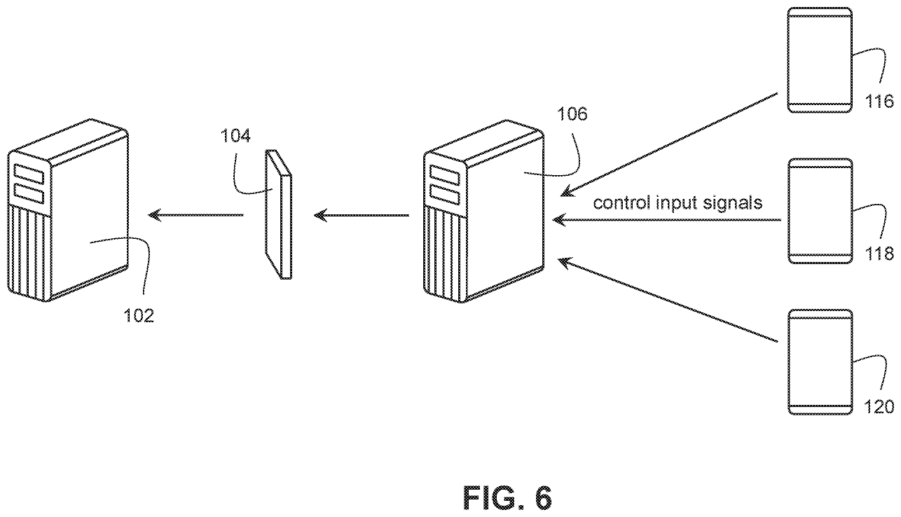

In several embodiments of the invention, the processor 107 receives control input signals from a client device (for example, the client device 116) and transmits the control input signals to the electronic device 102 through the SCD 104. The control input signals may be received from Human Interface Devices (HIDs), such as keyboard, mouse, touchpad, joystick, trackball, etc., installed with the plurality of client devices 116, 118, and 120. FIG. 6 illustrates an information flow diagram depicting the transmission of control input signals from the plurality of client devices 116, 118, and 120 to the electronic device 102, through the SCD 104, in accordance with an embodiment of the present invention. In that regard, the master processor 154 may receive the control input signals through the first SCD communication interface 152 and transmit the control input signals to the slave processor 156. The slave processor 156 would then transmit the control input signals to the electronic device 102 through the second SCD communication interface 158. The control input signals allow the users to control the electronic device 102 remotely using locally installed HIDs as listed above.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

Included in this invention is an alternative implementation that includes an electronic device 102 and a web server 114. In several embodiments of the invention, the web server 114 may include the capabilities of a WebRTC server for facilitating real-time communication between devices through peer-to-peer (P2P) communication. In several alternate embodiments of the invention, the web server 114 may be built-in or coded with the application server 106, without departing from the scope of the invention.

A user can select this alternative implementation if an application server 106 is not available. This alternative implementation contains a client software application that will be installed in electronic device 102. It contains software emulation of mouse, keyboard, gamepad and other types of control devices. Both software and hardware mouse are available in this implementation. In this alternative implementation, the audiovisual data is collected using software audio and video grabbers which can be a combination of capturing software and video-audio capture libraries. The audiovisual data is encoded and converted to RTMP live stream or other real-time streaming protocols. It will be sent to a web server 114 or application server 106, for example a WebRTC server, and the stream can be accessed by client software such as web browsers or dedicated stand-alone applications. When a user types a URL into a web browser (acting as a client), the browser sends an HTTP request to the web server that hosts the website. The web server then processes the request and sends back an HTTP response that contains the requested content. Upon detecting system capabilities and adjusting the settings based on available resources for top performance, the web server 114 will present available implementations based on available resources, and a user can choose either implementation for remote access to an electronic device.

1. A computer-implemented method for providing remote access to an electronic device, the computer-implemented method comprising:
receiving data from the electronic device through a wired and/or a wireless connection;
encoding the received data into a format configured for streaming over a Wide Area Network (WAN);
modifying the encoded data using an Artificial Intelligence (AI) based algorithm to augment broadcast characteristics of the encoded data and generating AI-augmented broadcast data; and
broadcasting the AI-augmented broadcast data to a client device associated with a user, through the WAN.

2. The computer-implemented method as claimed in claim 1, wherein the electronic device is selected from a group consisting of notebook PCs, tablet PCs, desktop PCs, web cameras, television sets, medical devices, and electronic devices capable of generating audiovisual data.

3. The computer-implemented method as claimed in claim 1, wherein the wired connection with the electronic device comprises connection through one or more of an Ethernet cable, a Video Graphics Array (VGA) cable, a High-Definition Multimedia Interface (HDMI) cable, Serial Digital Interface (SDI) cable, and a Universal Serial Bus (USB) cable.

4. The computer-implemented method as claimed in claim 1, wherein the data comprises audiovisual data comprising aural data, visual data, and image data.

5. The computer-implemented method as claimed in claim 4, wherein the audiovisual data is collected using capturing software and video-audio capture libraries.

6. The computer-implemented method as claimed in claim 1, further comprising training the AI-based algorithm with the data in raw format, received from the electronic device, and/or encoded data generated after the step of encoding.

7. The computer-implemented method as claimed in claim 1, wherein the AI-based algorithm is accessed from one or more of an Edge computing node and a cloud computing node.

8. The computer-implemented method as claimed in claim 1, wherein the AI-based algorithm is accessed locally using a non-dedicated node.

9. The computer-implemented method as claimed in claim 1, further comprising receiving control input signals from the client device and transmitting the control input signals to the electronic device through a Standalone Control Dongle (SCD).

10. The computer-implemented method as claimed in claim 1, wherein the AI-augmented broadcast data is broadcasted using a web server.

11. A computer system for providing remote access to an electronic device, the computer system comprising:
a processor; and
a memory unit operably connected to the processor, the memory unit configured to store machine-readable instructions, the machine-readable instructions when executed by the processor, enable the processor to:
receive data from the electronic device through a wired and/or a wireless connection;
encode the received data into a format configured for streaming over a Wide Area Network (WAN);
modify the encoded data using an Artificial Intelligence (AI) based algorithm to augment broadcast characteristics of the encoded data and generate AI-augmented broadcast data; and
broadcast the AI-augmented broadcast data to a client device associated with a user, through the WAN.

12. The computer system as claimed in claim 11, wherein the electronic device is selected from a group consisting of notebook PCs, tablet PCs, desktop PCs, web cameras, television sets, medical devices, and electronic devices capable of generating audiovisual data.

13. The computer system as claimed in claim 11, wherein the wired connection with the electronic device comprises connection through one or more of an Ethernet cable, a Video Graphics Array (VGA) cable, a High-Definition Multimedia Interface (HDMI) cable, and a Universal Serial Bus (USB) cable.

14. The computer system as claimed in claim 11, wherein the data comprises audiovisual data comprising aural data, visual data, and image data.

15. The computer system as claimed in claim 14, wherein the processor is further enabled to collect the audiovisual data using capturing software and video-audio capture libraries.

16. The computer system as claimed in claim 11, wherein the processor is further enabled to train the AI-based algorithm with the data in raw format, received from the electronic device, and/or the encoded data.

17. The computer system as claimed in claim 11, wherein the processor is further enabled to access the AI-based algorithm from one or more of an Edge computing node and a cloud computing node.

18. The computer system as claimed in claim 11, wherein the processor is further enabled to access the AI-based algorithm locally using a non-dedicated node.

19. The computer system as claimed in claim 11, wherein the processor is further enabled to receive control input signals from the client device and transmit the control input signals to the electronic device through a Standalone Control Dongle (SCD).

20. The computer system as claimed in claim 11, wherein the processor is further enabled to broadcast the AI-augmented broadcast data using a web server.
